(19) United States
(12) Patent Application Publication
(10) Pub. No.: US 2008/0150859 A1
(43) Pub. Date: Jun. 26, 2008

(54) LIQUID CRYSTAL DISPLAY DEVICE AND METHOD OF DRIVING THE SAME

(75) Inventors: Seock Cheon SONG, Suwon-si (KR); Jun Young LEE, Yongin-si (KR); Sung Wook KANG, Seoul (KR)

Correspondence Address: CANTOR COLBURN, LLP, 20 Church Street, 22nd Floor, Hartford, CT, 06103, US

(73) Assignee: SAMSUNG ELETRONICS CO., LTD., Suwon-si (KR)

(21) Appl. No.: 11/960,935

(22) Filed: Dec. 20, 2007

(30) Foreign Application Priority Data
Dec. 20, 2006 (KR) 1020060130863

(51) Int. Cl. G09G 3/36

(52) U.S. Cl. 345/87

(57) ABSTRACT

A liquid crystal display (“LCD”) device reduces the size of a liquid crystal (“LC”) panel by reducing the number of data voltage supply lines of the LC panel. The LCD device includes sub-pixels formed in a display area of a substrate, data lines formed in the display area in a column direction and commonly connected to the sub-pixels, gate lines crossing the data lines and respectively connected to the sub-pixels, data voltage supply lines receiving a data voltage from outside and supplying the data voltage to the data lines, branch lines branched from each of the data voltage supply lines, and switching elements formed between the branch lines and the data lines and selectively connecting the branch lines with the data lines. A method of driving the LCD device is further provided.

This application claims priority to Korean Patent Application No. 10-2006-0130863, filed on Dec. 20, 2006, and all the benefits accruing there from under 35 U.S.C. §119, and the contents of which in its entirety are herein incorporated by reference.

### BACKGROUND OF THE INVENTION

1. Field of the Invention

The present invention relates generally to a liquid crystal display (“LCD”) device and a method of driving the LCD device. More particularly, the present invention relates to an LCD device that reduces the size of a liquid crystal (“LC”) panel, and a method of driving the LCD device.

2. Description of the Related Art

Liquid crystal display (“LCD”) devices are a type of flat panel display device that displays an image by supplying an electric field to a liquid crystal (“LC”) panel and adjusting the light transmittance of an LC layer within the LC panel by rotating LC molecules in the LC layer according to the intensity of the electric field. The LC panel includes a color filter substrate, a thin film transistor (“TFT”) substrate facing the color filter substrate, and the LC layer interposed between the two substrates.

The LCD devices have various advantages including being thin in thickness, light in weight, low in power consumption and excellent in display quality, as compared with conventional cathode ray tube (“CRT”) monitors.

FIG. 1 is a schematic diagram illustrating a conventional LCD device according to the prior art.

Referring to FIG. 1, a conventional LCD device includes gate lines GL, data lines DL, red R, green G, and blue B sub-pixel areas, thin film transistors (“TFTs”) formed in the respective sub-pixel areas, an LC panel 6 in which pixel electrodes 3 connected to the TFTs are formed, and a gate driver 4 and a data driver 5 driving the LC panel 6. The R, G, and B sub-pixel areas are arranged in a horizontal direction and the sub-pixel areas having the same color are arranged in a vertical direction. The respective R, G, and B sub-pixel areas are driven by charging the pixel electrodes 3 with a data voltage supplied from the data driver 5 through the data lines DL according to a scan signal supplied from the gate driver 4 through the gate lines GL. Data voltage supply lines (not shown) are formed between the data lines DL and the data driver 5 to supply the data voltage to the data lines DL. The data voltage supply lines are formed in a non-display area of the LC panel 6. when the data driver 5 is formed on one side of the LC panel 6, the data voltage supply lines should be formed in the same number as the data lines DL. Moreover, the data voltage supply lines are formed spaced apart from each other at a predetermined interval such as about 3 μm to 5 μm to prevent signal interference. To increase the resolution of the LCD device, the numbers of the data lines DL and the data voltage supply lines should increase. when the number of the data voltage supply lines is increased, the size of an area in which the data voltage supply lines are formed should be increased and thereby the size of the non-display area of the LC panel 6 is increased. As a result, the size of the LCD device is increased.

### BRIEF SUMMARY OF THE INVENTION

Aspects of the present invention provide a liquid crystal display (“LCD”) device and a driving method of the LCD device capable of reducing the size of the LCD device by reducing the number of data voltage supply lines formed in a non-display area.

In exemplary embodiments of the present invention, an LCD device includes a plurality of sub-pixels formed in a display area of a substrate, a plurality of data lines formed in the display area in a column direction and commonly connected to the plurality of sub-pixels, a plurality of gate lines which crosses the data lines and respectively connects to the plurality of sub-pixels, a plurality of data voltage supply lines which receives a data voltage from the outside and supplies the data voltage to the data lines, a plurality of branch lines branched from each of the data voltage supply lines, and a plurality of switching elements formed between the plurality of branch lines and the plurality of data lines and which selectively connects the branch lines and the data lines.

The plurality of sub-pixels may include a plurality of thin film transistors (“TFTs”) connected to the gate lines and the data lines, respectively, and a plurality of pixel electrodes connected to the TFTs.

For each of the data voltage supply lines, when one of the switching elements, formed between the branch lines and the data lines selectively connected to the branch lines, is turned on, then remaining switching elements, formed between the branch lines and the data lines selectively connected to the branch lines, may be turned off.

The switching elements may be integrated on the substrate. The switching elements may be formed in a non-display area corresponding to an outer portion of the display area. The data voltage supply lines may be formed in the non-display area.

The plurality of sub-pixels may be formed in a column direction and may be arranged in sequential order of red, green and blue. The plurality of sub-pixels arranged in parallel to the gate lines may display the same color.

The LCD device may further include a gate driver which supplies a gate-on voltage and a gate-off voltage to the gate lines, a data driver which supplies the data voltage to data voltage supply lines every time when the gate-on voltage is supplied, a timing controller which supplies control signals to the gate driver and the data driver and which supplies switching control signals for turning on and off the switching elements, and a power supply which generates a driving voltage and supplies the driving voltage to the gate driver and the data driver.

The gate driver, the data driver, the timing controller and the power supply may be integrated into a single driving integrated circuit (“IC”) and mounted on the substrate. The gate driver may be integrated in the non-display area of the substrate. The data driver, the timing controller and the power supply may be integrated into a single driving IC and mounted on the substrate.

In other exemplary embodiments of the present invention, a method of driving an LCD device includes sequentially supplying a gate-on voltage to gate lines connected to a plurality of sub-pixels, and sequentially supplying a data voltage to a plurality of data lines via data voltage supply lines, during a time period for supplying the gate-on voltage divided by a number of branch lines branched from each data voltage supply line.

Supplying the data voltage to the plurality of data lines may include sequentially turning on and off switching elements formed between the branch lines and the data lines. Turning on and off the switching elements may include turning on and off the switching elements during a previous frame, and turning on and off the switching elements during a next frame in reverse order to the previous frame. Turning on and off the switching elements may include supplying a switch control signal from a timing controller to the switching elements to sequentially turn on and off the switching elements.

The method of driving the LCD device may further include sequentially outputting a red data voltage as many times as the number of the branch lines from a data driver to the data voltage supply lines, outputting a green data voltage as many times as the number of the branch lines to the data voltage supply lines after outputting the red data voltage, and outputting a blue data voltage as many times as the number of the branch lines to the data voltage supply lines after outputting the green data voltage.

In still other exemplary embodiments of the present invention, an LCD device includes first and second data lines, a data voltage supply line which transmits a data voltage to the first and second data lines, first and second branch lines which extend from the data voltage supply line, and first and second switching elements formed between the first and second branch lines and the first and second data lines, respectively, and which selectively connect the first and second branch lines to the first and second data lines.

When the first switching element is turned on, the second switching element may be turned off, and when the second switching element is turned on, the first switching element may be turned off. The LCD device may further include a gate line crossing the first and second data lines, wherein the first switching element may be turned on during one half cycle of a gate-on voltage applied to the gate line, and the second switching element may be turned on during another half cycle of the gate-on voltage applied to the gate line.

### BRIEF DESCRIPTION OF THE DRAWINGS

The above and other features and advantages of the present invention will become more apparent by describing exemplary embodiments thereof with reference to the accompanying drawings, in which:

FIG. 1 is a block diagram schematically illustrating a conventional LCD device according to the prior art;

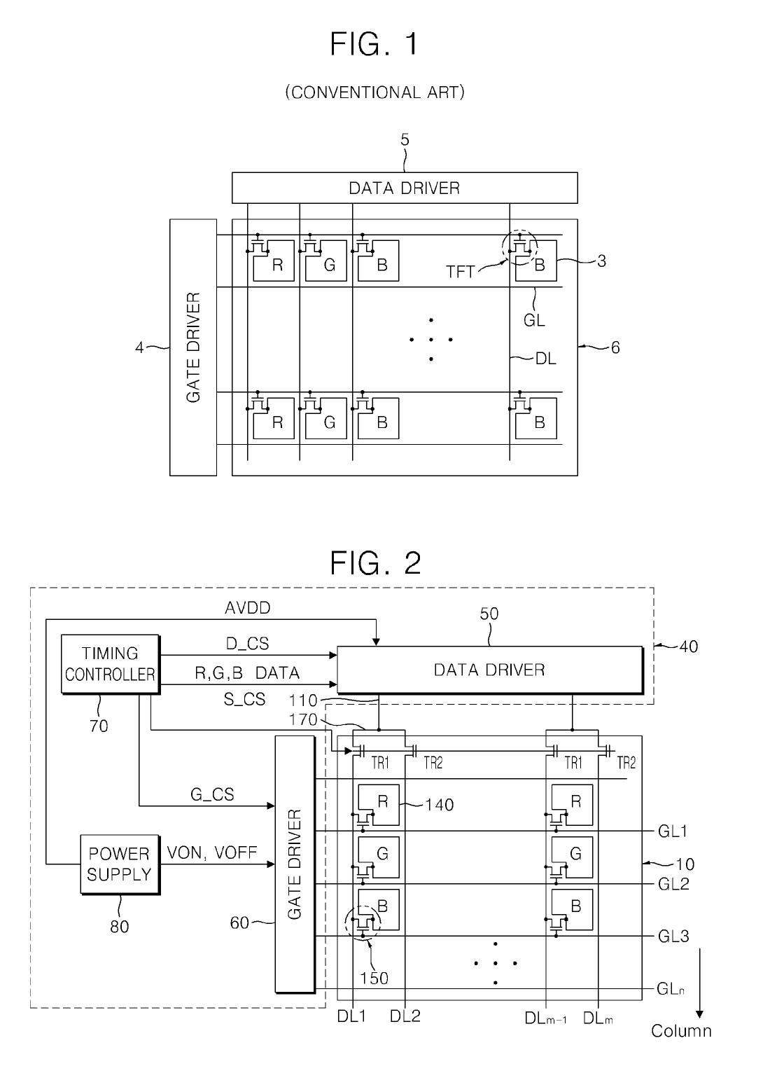

FIG. 2 is a block diagram schematically illustrating an exemplary LCD device in accordance with an exemplary embodiment of the present invention;

FIG. 3 is a plan view showing an exemplary TFT substrate and an exemplary color filter substrate of an exemplary LCD device in accordance with exemplary embodiments of the present invention;

FIG. 4 is a plan view showing pixel areas of the exemplary TFT substrate of the exemplary LCD device of FIG. 3;

FIG. 5 is a plan view showing an exemplary LCD device in accordance with another exemplary embodiment of the present invention; and

FIGS. 6 and 7 are timing diagrams illustrating an exemplary driving method of an exemplary LCD device in accordance with exemplary embodiments of the present invention.

### DETAILED DESCRIPTION OF THE INVENTION

The invention now will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, when the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

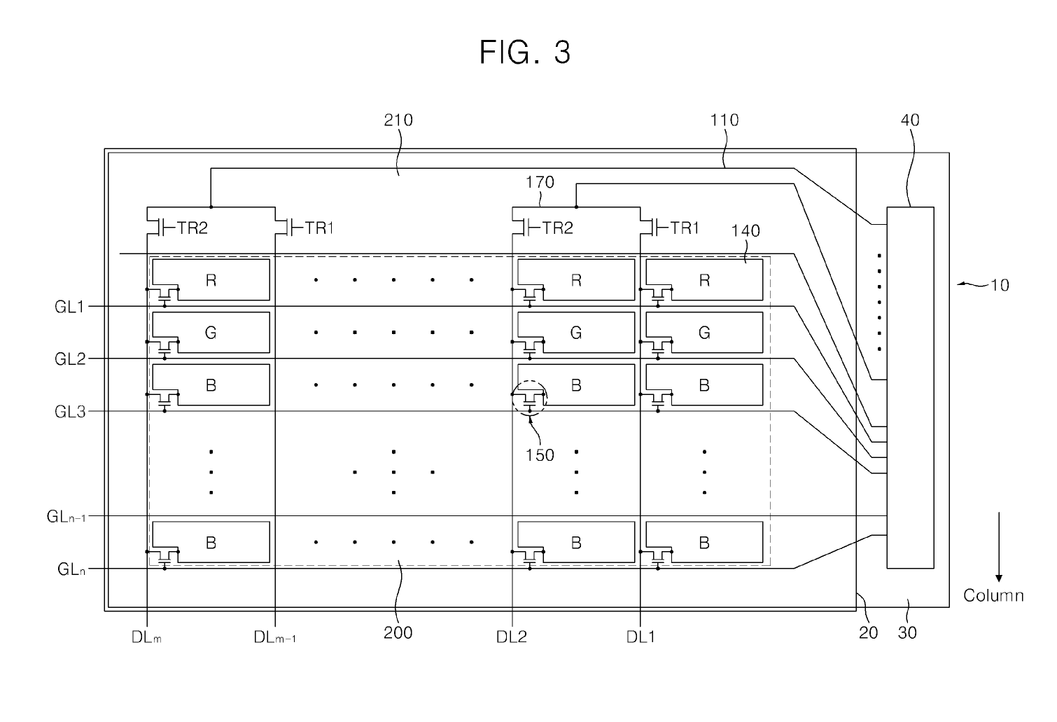

Hereinafter, exemplary embodiments of the present invention will now be described in detail with reference to FIGS. 2 to 6.

FIG. 2 is a block diagram illustrating an exemplary LCD device in accordance with an exemplary embodiment of the present invention.

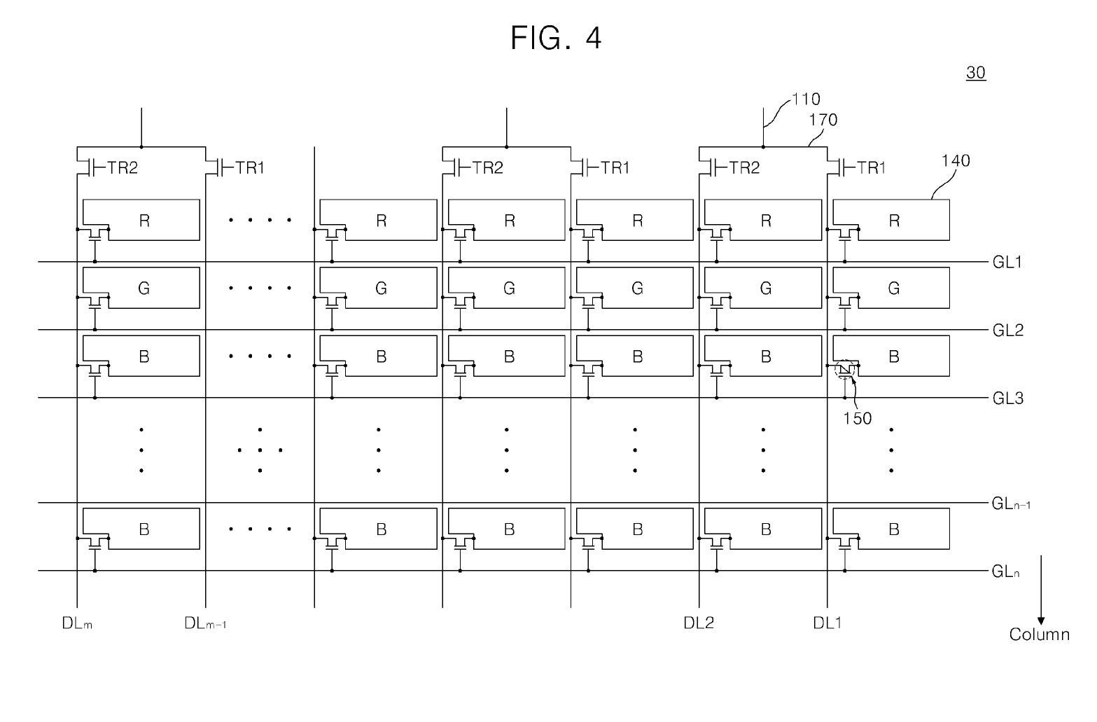

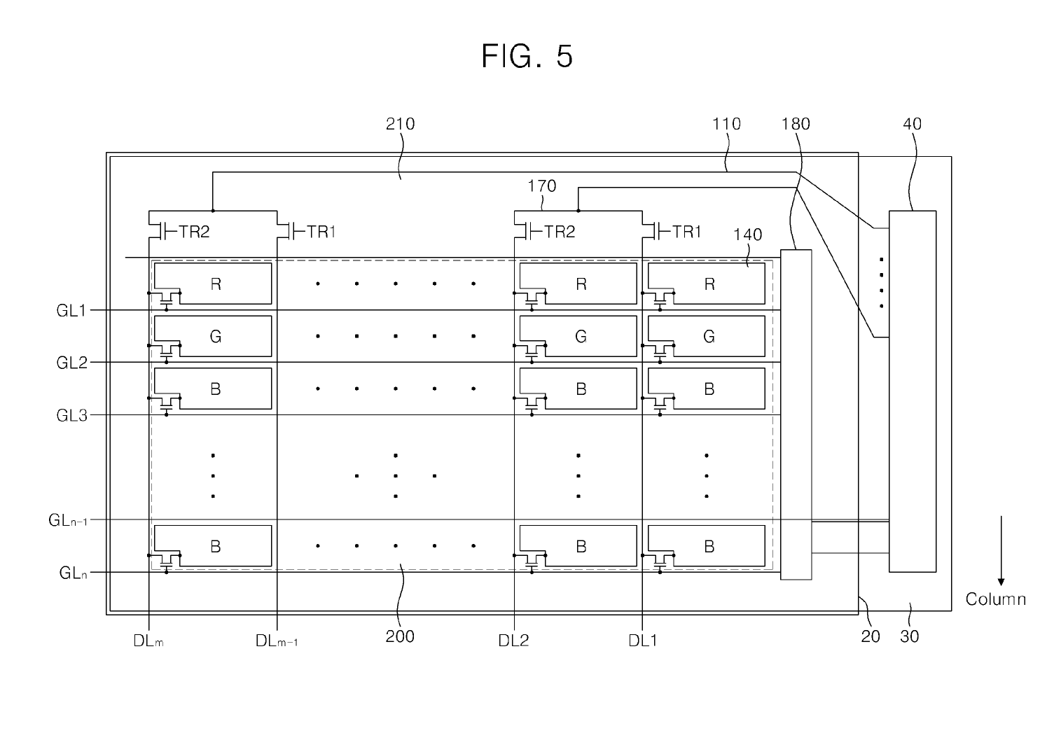

As shown in FIG. 2, an LCD device includes an LC panel 10 displaying an image, a gate driver 60 driving gate lines GL1 to GLn of the LC panel 10, a data driver 50 driving data lines DL1 to DLm of the LC panel 10, a timing controller 70 supplying control signals to the gate and data drivers 60 and 50, and a power supply 80 supplying power signals to the gate and data drivers 60 and 50. The data driver 50 sequentially receives a plurality of data voltages through one output line. To this end, a thin film transistor (“TFT”) substrate 30 (see FIGS. 3 and 4) of the LC panel 10 includes a plurality of data voltage supply lines 110 formed to connect output terminals of the data driver 50 to the data lines DL1 to DLm. A plurality of branch lines 170 is formed at ends of the data voltage supply lines 110 to connect the data voltage supply lines 110 to the data lines DL1 to DLm. Switching elements TR1 and TR2 selectively turned on and off are formed between the branch lines 170 and the data lines DL1 to DLm.

In more detail, the LC panel 10 includes a color filter substrate 20 (see FIG. 3) on which a color filter array is formed, the TFT substrate 30, on which a TFT array is formed, facing the color filter substrate 20, and a liquid crystal layer interposed therebetween, in which red R, green G and blue B sub-pixels are repeatedly arranged in a column direction.

To drive the LC panel 10, the LCD device includes the gate driver 60, the data driver 50, the timing controller 70 and the power supply 80.

The power supply 80 generates an analog driving voltage AVDD, a gate-on voltage VON and a gate-off voltage VOFF using a driving voltage input from the outside. The analog driving voltage AVDD is supplied to the data driver 50, and the gate-on voltage VON and the gate-off voltage VOFF are supplied to the gate driver 60.

The timing controller 70 arranges R, G and B image data signals received from the outside and supplies the same to the data driver 50. The timing controller 70 generates a plurality of control signals for controlling driving timings of the data driver 50 and gate driver 60 using a plurality of synchronization signals, such as a dot clock, a data enable signal, a vertical synchronization signal, a horizontal synchronization signal, etc., input together with the image data signals from the outside, and supplies the same to the data driver 50 and the gate driver 60. For example, the timing controller 70 generates gate control signals G_CS including a gate start pulse STV, a gate shift clock CPV, an output control signal OE, etc. and supplies the same to the gate driver 60. Moreover, the timing controller 70 generates data control signals D_CS including a data start pulse D_STV, a data shift clock D_CPV, a polarity control signal POL, etc. and supplies the same to the data driver 50. Furthermore, the timing controller 70 generates switching control signals S_CS for turning on and off the first and second switching elements TR1 and TR2, and supplies the same to the first and second switching elements TR1 and TR2. In this case, the switching control signals S_CS are synchronized with the gate control signals G_CS and the data control signals D_CS supplied to the gate driver 60 and the data driver 50 and then supplied to the first and second switching elements TR1 and TR2. That is, while supplying the gate control signals G_CS to the gate driver 60 so that the gate-on voltage VON is output to the gate lines GL1 to GLn, and while supplying the data control signals D_CS to the data driver 50 so that the data voltages are output to the data voltage supply lines 110, the timing controller 70 supplies signals reversed at a half cycle of the gate-on voltage VON, i.e., the switching control signals S_CS to the first and second switching elements TR1 and TR2. Accordingly, the first and second switching elements TR1 and TR2 are sequentially turned on and off. Moreover, after the previous frame, the timing controller 70 supplies the switching control signals S_CS, having phases reversed with respect to those of the previous frame, to the first and second switching elements TR1 and TR2 to be turned on and off in reverse order to the previous frame, as will be further described below.

The data driver 50 converts a digital data voltage into an analog data voltage in response to the data control signal D_CS from the timing controller 70, and supplies the converted analog data voltage to the data lines DL1 to DLm every time when the gate-on voltage VON is supplied to the gate lines GL1 to GLn of the LC panel 10. The data driver 50 includes a shift register, a latch, a digital/analog converter, and an output buffer. The shift register sequentially shifts the data start pulse D_STV according to the data shift clock D_CPV and generates a sampling signal. The latch sequentially latches the R, G and B data signals from the timing controller 70 in response to the sampling signal and, when the data corresponding to one horizontal line is latched, outputs the same to the digital/analog converter at the same time.

The digital/analog converter selects a gamma voltage, corresponding to the data signal from the latch, from a plurality of gamma voltages and outputs the same as an analog data voltage. The output buffer buffers the converted analog data voltage from the digital/analog converter and supplies the same to the data voltage supply line 110. In this case, the output buffer of the data driver 50 includes a switch for time-dividing the data voltage to sequentially supply the analog data voltages transmitted from the digital/analog converter to the data voltage supply lines 110 in time. For example, the output buffer switches the respective analog data voltages of red R, green G and blue B supplied from the digital/analog converter to first and second columns to be arranged in the sequential order of a red R sub-pixel of the first column, a red R sub-pixel of the second column, a green G sub-pixel of the first column, a green G sub-pixel of the second column, a blue B sub-pixel of the first column, and a blue B sub-pixel of the second column, and outputs the switched data voltage to one of the data voltage supply lines 110 selectively connected to the data line of the first and second columns. Simultaneously, the output buffer supplies the converted analog data voltages to the rest of the data voltage supply lines 110 in the same order as above.

Meanwhile, the digital/analog converter selects a positive or negative polarity gamma voltage according to the polarity control signal POL from the timing controller 70, and outputs the same as the analog data voltage. Especially, the digital/analog converter outputs data voltages having polarities opposite to each other to adjacent output channels in response to the polarity control signal POL corresponding to a vertical dot inversion method so that the polarities of the data voltages supplied through the output channels may be inverted in a horizontal period unit.

The gate driver 60, the data driver 50, the power supply 80 and the timing controller 70 may be integrated into a driving integrated circuit (“IC”) 40 (see FIG. 3). In an alternative exemplary embodiment, the gate driver 60, the data driver 50 and the power supply 80 except for the timing controller 70 may be integrated into the driving IC 40. In still another exemplary embodiment, the gate driver 60 and the data driver 50 may be integrated on the TFT substrate 30 and the power supply 80 and the timing controller 70 may be integrated into the driving IC 40.

FIG. 3 is a plan view showing an exemplary TFT substrate and an exemplary color filter substrate of an exemplary LCD device in accordance with the exemplary embodiment of the present invention, and FIG. 4 is a plan view showing pixel areas of the exemplary TFT substrate of the exemplary LCD device of FIG. 3.

As shown in FIGS. 3 and 4, the color filter substrate 20 includes a black matrix dividing sub-pixel areas on an upper substrate, red R, green G and blue B color filters formed in the sub-pixel areas divided by the black matrix, and a common electrode formed on the color filters and receiving a common voltage. The R, G and B color filters are repeatedly arranged in the column direction.

The TFT substrate 30 includes the gate lines GL1 to GLn, the data lines DL1 to DLm, TFTs 150 formed in the respective sub-pixel areas and connected to the gate lines GL1 to GLn and the data lines DL1 to DLm, and pixel electrodes 140 formed in the respective sub-pixel areas and connected to the TFTs 150. In an exemplary embodiment, the sub-pixel areas may be intersections between the gate lines GL1 to GLn and the data lines DL1 to DLm. In this case, R, G and B sub-pixel areas are repeatedly arranged in the column direction corresponding to the R, G and B color filters of the color filter substrate 20.

The TFTs 150 are turned on by the gate-on voltage VON supplied from the gate lines GL1 to GLn and supply the data voltage received from the data lines DL1 to DLm to the pixel electrodes 140. Each of the TFTs 150 includes a gate electrode, a gate insulating layer (not shown) formed on the gate electrode, a semiconductor layer (not shown) and an ohmic contact layer (not shown) formed on the gate insulating layer, and source and drain electrodes formed to face each other on the ohmic contact layer.

The gate electrodes are electrically connected to the gate lines GL1 to GLn. The gate electrodes are formed of the same metal as the gate lines GL1 to GLn on the same layer of the TFT substrate 30. The gate insulating layer formed of an inorganic material such as, silicon nitride (SiNx) or silicon oxide (SiOx) is formed all over the substrate 30 on which the gate lines GL1 to GLn and the gate electrodes are formed. The gate insulating layer prevents the gate lines GL1 to GLn and the gate electrodes from being in contact with other signal lines or electrodes. The semiconductor layer is formed to overlap the gate electrodes on the gate insulating layer. The semiconductor layer may be formed of amorphous-silicon (“a—Si”) and forms a channel of the TFT 150. The TFT 150 includes the ohmic contact layer for providing ohmic contact between the semiconductor layer and the source and drain electrodes. The ohmic contact layer may be formed of a—Si doped with impurities, n+a—Si for example. The source electrode is formed to overlap the semiconductor layer on the ohmic contact layer. The source electrode electrically connected to the data line DLm supplies a pixel data voltage transmitted from data line DLm to the drain electrode, when the TFT 150 is turned on. The source electrode is formed of the same metal as the data line DLm on the same layer of the TFT substrate 30. The drain electrode which is separated from the source electrode and the data line DLm is formed to face the source electrode and overlap the semiconductor layer on the ohmic contact layer.

As shown in FIG. 3, the R, G and B sub-pixel areas are formed along the gate lines GL1 to GLn, and the R, G and B sub-pixel areas are repeatedly formed along the column direction. Accordingly, one pixel area including the R, G and B sub-pixel areas is connected to three gate lines GL1, GL2 and GL3 and one of the data lines DL1 to DLm. In one exemplary embodiment, the first gate line GL1 is connected to the R sub-pixel area, the second gate line GL2 is connected to the G sub-pixel area, and the third gate line GL3 is connected to the B sub-pixel area. The first to third gate lines GL1 to GL3 are repeatedly formed along the horizontal direction. Accordingly, each of the gate lines GL1 to GLn is connected to the TFTs 150 formed in the sub-pixel areas displaying the same color. Moreover, each of the data lines DL1 to DLm is commonly connected to the TFTs 150 formed in the respective sub-pixel areas along the column direction.

As a result, the number of the gate lines GL1 to GLn is increased by three times compared to the conventional LCD device, however, the number of the data lines DL1 to DLm is decreased by three times compared to the conventional LCD device.

The data voltage supply lines 110 supply the data voltage transmitted from the data driver 50 to the data lines DL1 to DLm. One side of the data voltage supply lines 110 is connected to the data lines DL1 to DLm, and the other side of the data voltage supply lines 110 is connected to the data driver 50. The data voltage supply lines 110 are formed in a non-display area 210 corresponding to an upper portion or a lower portion of a display area 200. In this case, the data voltage supply lines 110 are formed spaced apart from each other at a predetermined interval to prevent signal interference between adjacent data voltage supply lines 110. It is preferable that the interval between the data voltage supply lines 110 be formed within about 3.5 μm to about 5 μm. Each of the data voltage supply lines 110 is branched into a plurality of branch lines 170, and the branch lines 170 are connected to the respective data lines DL1 to DLm to supply the data voltage to the data lines DL1 to DLm. Since the data voltage supplied through one data voltage supply line 110 is sequentially supplied to the data lines DL1 to DLm in series, the switching elements TR1 and TR2 are provided between the branch lines 170 and the data lines DL1 to DLm to selectively supply the data voltage to the data lines DL1 to DLm.

In an exemplary embodiment of the present invention, for convenience of description, the following description will be given by dividing each of the data voltage supply lines 110 into two branch lines 170 so that the data voltage is supplied to the two branch lines 170 through one data voltage supply line 110.

In this exemplary embodiment, the two branch lines 170 branched from each of the data voltage supply line 110 are connected to, for example, first and second data lines DL1 and DL2 formed along first and second columns through the first and second switching elements TR1 and TR2. At this time, the first and second columns are repeatedly formed, in which the first data line DL1 is connected to the first switching element TR1, and the second data line DL2 is connected to the second switching element TR2. When one of the first and second switching elements TR1 and TR2 is turned on, the other one is turned off. In other words, the data voltage should be supplied to one of the data voltage supply lines 110 while the gate-on voltage VON is supplied to a corresponding sub-pixel connected to the gate line GLn. Accordingly, when the first switching element TR1 is turned on, the data voltage is supplied to the first data line DL1 driving the sub-pixel areas of the first column. At this time, the second switching element TR2 is turned off and thereby the data voltage is not supplied to the second data line DL2. when one of the first and second switching elements TR1 and TR2 includes a negatively-doped metal oxide semiconductor (“NMOS”) transistor, the other one includes a positively doped metal oxide semiconductor (“PMOS”) transistor. Accordingly, when the switching control signals S_CS are supplied to the first and second switching elements TR1 and TR2, one of the first and second switching elements TR1 and TR2 is turned on, and the other one is turned off. The switching control signals S_CS are supplied from the timing controller 70.

As described above, the number of the data voltage supply lines 110 in the LCD device in accordance with an exemplary embodiment of the present invention is reduced by ⅙ times compared to the conventional LCD device and thereby the size of the non-display area 210 is reduced, thus reducing the size of the TFT substrate 30. In alternative exemplary embodiments, it is possible to further reduce the number of the data voltage supply lines 110 using the switching elements TR1 and TR2. For example, when the number of the switching elements is three, such as by including first, second, and third switching elements TR1, TR2, and TR3, the number of the data voltage supply lines 110 is reduced by 1/9 times, whereas when the number of the switching elements is 4, such as by including first, second, third, and fourth switching elements TR1, TR2, TR3, and TR4, the number of the data voltage supply lines 110 is reduced by 1/12 times compared to the conventional LCD device. Accordingly, it is possible to reduce the number of the data voltage supply lines 110 according to the number of the switching elements.

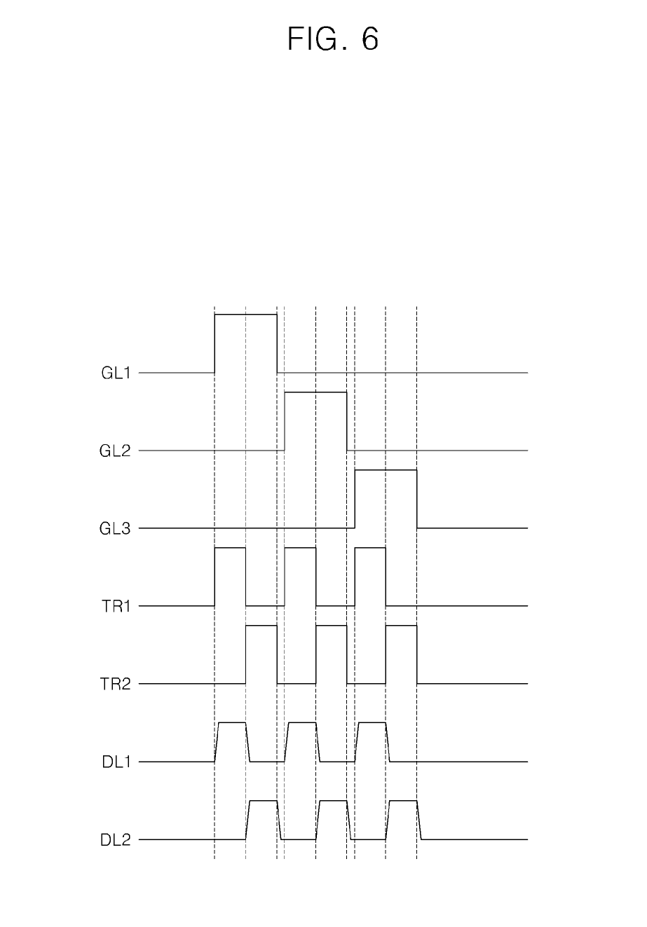

FIG. 5 is a plan view showing an exemplary LCD device in accordance with another exemplary embodiment of the present invention.

Since the LCD device shown in FIG. 5 has substantially the same elements as those in FIG. 3, except for a gate driver 180 integrated on the TFT substrate 30, the detailed description of the substantially same elements will be omitted.

As shown in FIG. 5, a gate driver 180 is formed in a non-display area 210 of the TFT substrate 30. The gate driver 180 receives the gate-on voltage VON, the gate-off voltage VOFF, and the gate control signal G-CS from the driving IC 40, and sequentially supplies the gate-on voltage VON and the gate-off voltage VOFF to the gate lines GL1 to GLn. The gate driver 180 is integrated on the TFT substrate 30. In other words, the gate driver 180 is formed on one side of the TFT substrate 30 as an amorphous-silicon gate (“ASG”). As in the illustrated exemplary embodiment, it is preferable that the gate driver 180 be formed in the non-display area 210 between the driving IC 40 and the display area 200. The gate driver 180 includes a plurality of transistors and thereby one of shift registers supplies the gate-on voltage VON and the gate-off voltage VOFF to one of the gate lines GL1 to GLn. The shift registers are formed in series. The transistors included in the gate driver 180 are formed at the same time when the TFTs 150 are formed on the TFT substrate 30.

The data driver 50, the power supply 80 and the timing controller 70 may be integrated into the driving IC 40 as a single chip. Alternatively, the data driver 50 and the power supply 80 may be integrated into the driving IC 40 and the timing controller 70 may be formed as a separate chip.

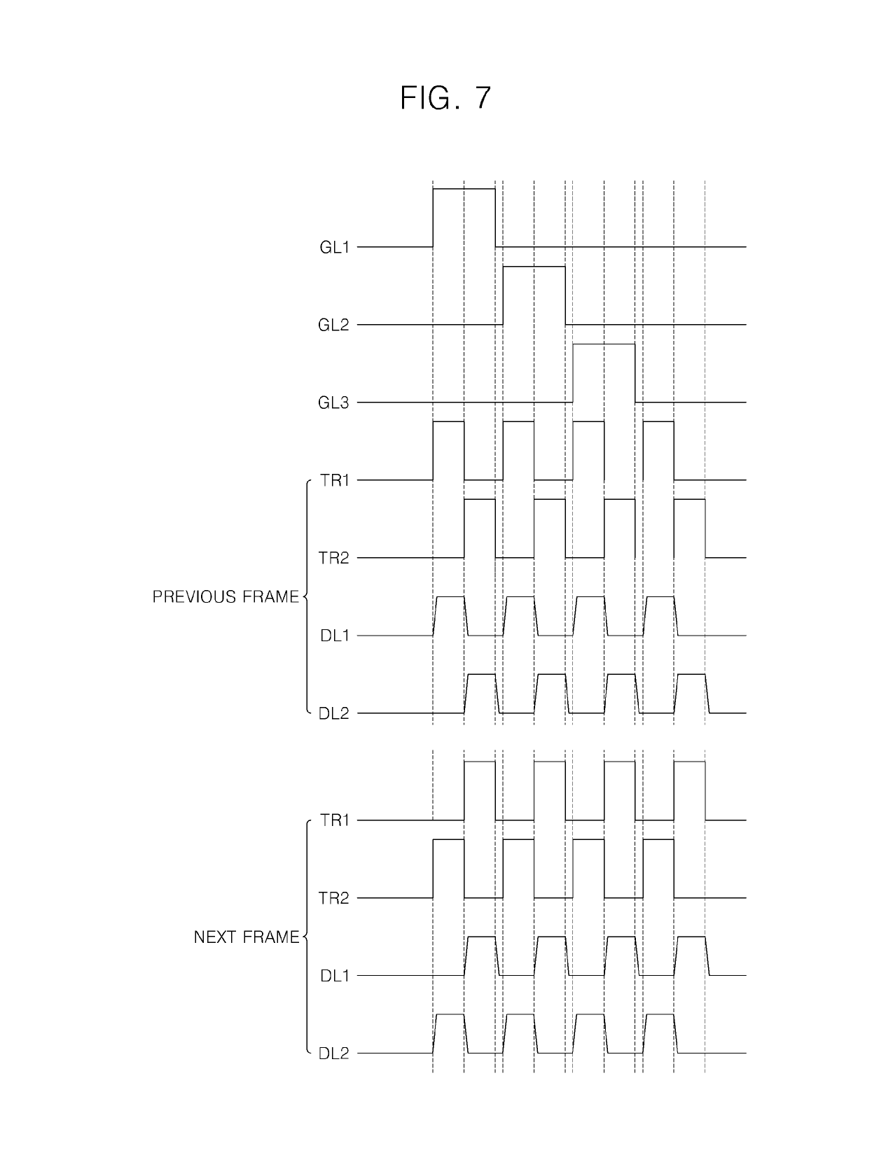

FIGS. 6 and 7 are timing diagrams illustrating an exemplary driving method of an exemplary LCD device in accordance with the exemplary embodiment of the present invention.

As shown in FIGS. 6 and 7, when the gate-on voltage VON is supplied to the first gate line GL1 connected to the TFT 150 formed in the R sub-pixel area of the first column, the first switching element TR1 is turned on to supply the data voltage to the first data line DL1. At the same time, the second switching element TR2 is turned off so as not to supply the data voltage to the second data line DL2. In this case, the first switching element TR1 is turned on for a half cycle of the gate-on voltage VON and then turned off. At the end of the half cycle of the gate-on voltage VON, the second switching element TR2 is turned on to supply the data voltage to the second data line DL2 at the same time when the first switching element TR1 is turned off. Although a description of the exemplary driving method has been made with respect to only the first and second columns, the other columns are also driven in the same manner as described above.

Next, when the gate-on voltage VON is supplied to the second gate line GL2, the gate-off voltage VOFF is supplied to the first gate line GL1 to turn off the TFTs 150 formed in the sub-pixel areas of the first gate line GL1. Moreover, when the gate-on voltage VON is supplied to the second gate line GL2, the first switching element TR1 is turned on to supply the data voltage transmitted from the data voltage supply line 110 to the first data line DL1. Then, the TFT 150 formed in the G sub-pixel area of the first column is turned on and thereby the pixel electrode 140 formed in the G sub-pixel area of the first column is charged. At this time, the first switching element TR1 maintains the turn-on state for the half cycle of the second gate line GL2 and then is turned off. Subsequently, when the first switching element TR1 is turned off, the second switching element TR2 is turned on to supply the data voltage to the TFT 150 formed in the G sub-pixel area of the second column. Likewise, when the gate-on voltage VON is supplied to the third gate line GL3, the first switching element TR1 is turned on to turn on the TFT 150 formed in the B sub-pixel area of the first column. At this time, the first switching element TR1 is turned on again to supply the data voltage transmitted from the data voltage line 110 to the first data line DL1 and thereby the data voltage is charged in the pixel electrode 140 connected to the TFT 150 of the first column. Next, the first switching element TR1 is turned off after the half cycle of the gate-on voltage VON and, at the same time, the second switching element TR2 is turned on. Accordingly, the data voltage is supplied to the TFT 150 formed in the B sub-pixel area of the second column and thereby the data voltage is charged in the pixel electrode 140 in the B sub-pixel area of the second column. As described above, the first and second switching elements TR1 and TR2 are alternately turned on and off at the half cycle of the gate-on voltage VON to supply the data voltage to the first and second data lines DL1 and DL2, thus driving the LCD device. In the next frame, the LCD device is driven in a reverse manner to that described above, as will be further described with respect to FIG. 7.

As shown in FIG. 7, in the next frame, while the first gate line GL1 is driven, the second switching element TR2 is first turned on for the first half cycle of the gate-on voltage VON and then the first switching element TR1 is turned on for the second half cycle of the gate-on voltage VON. That is, the first and second switching elements TR1 and TR2 are turned on and off in reverse order to the previous frame. To this end, the timing controller 70 supplies the switching control signals S_CS to the first and second switching elements TR1 and TR2 in reverse order to the previous frame. Accordingly, in the next frame, the second column is driven prior to the first column.

Meanwhile, the LCD device in accordance with exemplary embodiments of the present invention may be driven in an inversion method such as, a dot inversion, a frame inversion, a line inversion, a column inversion, and the like.

As described above, according to the LCD device and the method of driving the LCD device in accordance with the exemplary embodiments of the present invention, the data voltage supply lines, the branch lines branched from the data voltage supply lines, the data lines connected to the branch lines, and the switching elements formed between the branch lines and the data lines are provided to reduce the number of data voltage supply lines formed in the non-display area of the TFT substrate, thus reducing the size of the LC panel.

Although exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A liquid crystal display device comprising:
a plurality of sub-pixels formed in a display area of a substrate;
a plurality of data lines formed in the display area in a first direction and commonly connected to the plurality of sub-pixels;
a plurality of gate lines formed in the display area in a second direction which crosses the data lines and respectively connects to the plurality of sub-pixels;
a plurality of data voltage supply lines which receives a data voltage from an outside and supplies the data voltage to the data lines;
a plurality of branch lines branched from each of the data voltage supply lines; and
a plurality of switching elements formed between the plurality of branch lines and the plurality of data lines and which selectively connects the branch lines and the data lines.

2. The liquid crystal display of claim 1, wherein the plurality of sub-pixels comprise a plurality of thin film transistors connected to the gate lines and the data lines, respectively, and a plurality of pixel electrodes connected to the thin film transistors.

3. The liquid crystal display of claim 1, wherein, when one of the switching elements, formed between the branch lines branched from each of the data voltage supply lines and the data lines, is turned on, the remaining switching elements are turned off.

4. The liquid crystal display of claim 1, wherein the switching elements are integrated on the substrate.

5. The liquid crystal display of claim 1, wherein the switching elements are formed in a non-display area corresponding to an outer portion of the display area.

6. The liquid crystal display of claim 1, wherein the switching elements turned on during a previous frame are turned off during a next frame, and switching elements turned off during a previous frame are turned on during a next frame.

7. The liquid crystal display device of claim 5, wherein the data voltage supply lines are formed in the non-display area.

8. The liquid crystal display device of claim 1, wherein the plurality of sub-pixels are formed in the first direction and are arranged in sequential order of red, green and blue.

9. The liquid crystal display device of claim 8, wherein the plurality of sub-pixels arranged in parallel to the gate lines display the same color.

10. The liquid crystal display device of claim 1, further comprising:
a gate driver which supplies a gate-on voltage and a gate-off voltage to the gate lines;
a data driver which supplies the data voltage to the data voltage supply lines every time when the gate-on voltage is supplied;
a timing controller which supplies control signals to the gate driver and the data driver and supplies switching control signals for turning on and off the switching elements.

11. The liquid crystal display device of claim 1, further comprising:
a power supply which generates a driving voltage and supplies the driving voltage to the gate driver and the data driver.

12. The liquid crystal display device of claim 10, wherein the gate driver, the data driver, the timing controller and the power supply are integrated into a single driving integrated circuit and mounted on the substrate.

13. The liquid crystal display device of claim 10, wherein the gate driver is integrated in a non-display area of the substrate.

14. The liquid crystal display device of claim 13, wherein the data driver and the timing controller are integrated into a single driving integrated circuit and mounted on the substrate.

15. A method of driving a liquid crystal display device, the method comprising:
sequentially supplying a gate-on voltage to gate lines connected to a plurality of sub-pixels; and
sequentially supplying a data voltage to a plurality of data lines via data voltage supply lines, during a time period for supplying the gate-on voltage divided by a number of branch lines branched from each data voltage supply line.

16. The method of claim 15, wherein supplying the data voltage to the plurality of data lines includes sequentially turning on and off switching elements formed between the branch lines and the data lines.

17. The method of claim 16, where turning on and off the switching elements includes switching elements turned on during a previous frame are turned off during a next frame and switching elements turned off during a previous frame are turned on during a next frame.

18. The method of claim 16, wherein turning on and off the switching elements includes supplying a switch control signal from a timing controller to the switching elements to sequentially turn on and off the switching elements.

19. The method of claim 15, further comprising:
sequentially outputting a red data voltage as many times as the number of the branch lines from a data driver to the data voltage supply lines;
outputting a green data voltage as many times as the number of the branch lines to the data voltage supply lines after outputting the red data voltage; and
outputting a blue data voltage as many times as the number of the branch lines to the data voltage supply lines after outputting the green data voltage.

20. A liquid crystal display device comprising:
first and second data lines;
a data voltage supply line which transmits a data voltage to the first and second data lines;
first and second branch lines which extend from the data voltage supply line; and,
first and second switching elements formed between the first and second branch lines and the first and second data lines, respectively, and which selectively connect the first and second branch lines to the first and second data lines.

21. The liquid crystal display device of claim 20, wherein when the first switching element is turned on, the second switching element is turned off, and when the second switching element is turned on, the first switching element is turned off.

22. The liquid crystal display device of claim 21, further comprising a gate line crossing the first and second data lines, wherein the first switching element is turned on during one half cycle of a gate-on voltage applied to the gate line, and the second switching element is turned on during another half cycle of the gate-on voltage applied to the gate line.
